(19) United States
(12) Patent Application Publication
(10) Pub. No.: US 2012/0234505 A1
(43) Pub. Date: Sep. 20, 2012

(54) GARAGE DOOR STORAGE SPACE UTILIZER

(75) Inventors: Timothy Robert HARTWIG, DeKalb, IL (US); Edward James HARTWIG, Sharon, WI (US)

(73) Assignee: GENHART LTD., DeKalb, IL (US)

(21) Appl. No.: 13/416,482

(22) Filed: Mar. 9, 2012

Related U.S. Application Data
(60) Provisional application No. 61/454,285, filed on Mar. 18, 2011.

(51) Int. Cl. F16M 13/02; E06B 5/00; F16M 13/00; B23P 17/04

(52) U.S. Cl. 160/127; 29/525.01; 248/315; 248/220.22

(57) ABSTRACT

An adjustable-length organizer has an elongate flexible strap with first and second sides, first and second ends, and an installed length. Multiple support loops are formed onto the first side of the elongate strap. Respective first fastener pieces are affixed to the second side of the elongate strap to be near each of the first and second ends. One or more second fastener pieces is affixed to the second side of the elongate strap to be remote from the first and second ends and to be inward of the respective first fastener pieces. The first end of the organizer is wrappable around a first anchor point, the second end is wrappable around a second anchor point, and each first fastener piece is attached to the second fastener piece at a plurality of positions, thereby making the installed length adjustable.

### BACKGROUND OF THE INVENTION

The garages of modern homeowners are notoriously cluttered with everything from boxes of clothes and toys to tools and sporting equipment. While there are a variety of organizers to help people get organized and save space, long, narrow objects, such as fishing poles, are particularly difficult to store because of their relatively long lengths and narrow bases. These objects can be laid down on a floor, taking up a large amount of space and posing a tripping hazard, or they can be leaned against a vertical surface, meaning that they are inherently unstable and can fall down and injure a person or become damaged. Thus, there is a need for an organizer that allows previously under-utilized areas to be used for storage and also permits some of these more troublesome objects to be stored quickly and easily.

### SUMMARY OF THE INVENTION

According to one aspect of the invention, a system for storing objects comprises a garage door having a plurality of panels and an organizer. At least one garage door panel is connected to two adjacent panels by a plurality of hinges. A first one of the hinges is separated from a second one of the hinges by a vertical spacing from the first hinge. The organizer includes a flexible elongate strap having a first side, a second side, a first end, and a second end that is remote from the first end. The organizer has a plurality of support loops on the first side of the elongate strap and a plurality of first fastener pieces affixed to the second side of the elongate strap. The respective first fastener pieces are proximate to each of the first and second ends. At least one second fastener piece is affixed to the second side of the elongate strap to be remote from the first and second ends, inward of the respective first fastener pieces.

The first and second ends are wrappable around portions of the first and second hinges, respectively. Each first fastener piece is affixable to the at least one second fastener piece at a plurality of positions, thereby making the installed length of the first organizer adjustable to the vertical spacing.

An adjustable-length organizer comprises an elongate flexible strap having a first side, a second side, a first end, a second end remote from the first end, and a plurality of support loops on the first side of the elongate strap. A plurality of first fastener pieces are affixed to the second side of the elongate strap, respective first fastener pieces being proximate to each of the first and second ends. At least one second fastener piece is affixed to the second side of the elongate strap to be remote from the first and second ends and inward of the respective first fastener pieces.

The first end is wrappable around a first anchor point, the second end is wrappable around a second anchor point, and each first fastener piece is affixable to the at least one second fastener piece at a plurality of positions, thereby making an installed length between anchor points adjustable.

In another embodiment, a system for storing objects comprises a first anchor point, a second anchor point, and a first organizer having an installed length adjustable to the distance between the first and second anchor points. The first organizer includes an elongate flexible strap having a first side, a second side, a first end, a second end, an installed length, and a plurality of support loops on the first side of the elongate strap. A plurality of first fastener pieces are affixed to the second side of the elongate strap, the respective first fastener pieces being proximate to the first and second ends. At least one second fastener piece is affixed to the second side of the elongate strap to be remote from the first and second ends and inward of the respective first fastener pieces. The first end is wrappable around the first anchor point, the second end is wrappable around the second anchor point, and each first fastener piece is affixable to the at least one second fastener piece at a plurality of positions, thereby making the installed length adjustable.

A method of storing objects comprises the steps of wrapping a first end of a first adjustable-length organizer around a first anchor point and affixing a first fastener piece that is proximate the first end of the first organizer to a second fastener piece that is remote from the first end and inward on the strap from the first fastener piece. A second end of the first organizer is wrapped around a second anchor point displaced from the first anchor point by a first installed length, and a first fastener piece that is proximate to the second end of the first organizer is affixed to a second fastener piece, which is remote from the second end and inward, on the strap, from the first fastener piece.

The method further includes the steps of wrapping a third end of a second adjustable-length organizer around a third anchor point, affixing a first fastener piece that is proximate the third end of the second organizer to a second fastener piece which is remote from the third end and inward on the strap from the first fastener piece, and wrapping a fourth end of the second organizer around a fourth anchor point displaced from the third anchor point by a second installed length. A first fastener piece which is proximate the fourth end of the second organizer is affixed to a second fastener piece that is remote from the fourth end and inward on the strap of the first fastener piece.

A first end of an object can be inserted into a loop that is affixed to a first side of the first organizer, and a second end of the object is inserted into a loop affixed to a first side of the second organizer. Preferably, the step of inserting the second end of the object further comprises the substeps of unattaching an adjustable end of the adjustable loop, inserting the second end of the object into adjustable loop, and reattaching the adjustable end.

A method of storing objects on a garage door having a plurality of panels and a plurality of hinges comprises the steps of wrapping a first end of a first adjustable-length organizer around a first garage door hinge and affixing a first fastener piece that is proximate the first end of the first organizer to a second fastener piece which is remote from the first end and inward, on the strap, from the first fastener piece. A second end of the first organizer is wrapped around a second garage door hinge which is vertically displaced from the garage door hinge by a first installed length. A first fastener piece that is proximate to the second end of the first organizer is affixed to a second fastener piece which is remote from the second end and inward, on the strap, from the first fastener piece.

A third end of a second adjustable-length organizer is wrapped around a third garage door hinge which is laterally displaced from the first garage door hinge. A first fastener piece that is proximate the third end of the second organizer is affixed to a second fastener piece which is remote from the third end and inward, on the strap, from the first fastener piece. A fourth end of the second organizer is wrapped around a fourth garage door hinge which is vertically displaced from the third garage door hinge by a second installed length. A first fastener piece which is proximate the fourth end of the second organizer is affixed to a second fastener piece which is remote from the fourth end and inward, on the strap, from the first fastener piece. A first end of an object is inserted into a loop that is affixed to a first side of the first organizer and a second end of the object may be inserted into a loop affixed to a first side of the second organizer.

### BRIEF DESCRIPTION OF THE DRAWINGS

Further aspects of the invention and their advantages can be discerned in the following detailed description, in which like characters denote like parts and in which:

FIG. 1 is a side view of a first organizer showing a first end, a second end, an adjustable loop, and a fixed loop;

FIG. 2 is an isometric view of a first side of the first organizer and a second side of a second organizer according to FIG. 1;

FIG. 3 is a front isometric view of the first and second organizers of FIG. 2 installed on a garage door;

FIG. 3A is a detail of FIG. 3, showing the organizer of FIG. 1 affixed to a garage door hinge as an anchor point; and

FIG. 4 is a flow diagram showing a method of storing objects.

### DETAILED DESCRIPTION

This invention relates to a storage device that is affixable to two or more anchor points. In particular, the invention is particularly well suited to hold elongate articles, which are often difficult to store due to their shape.

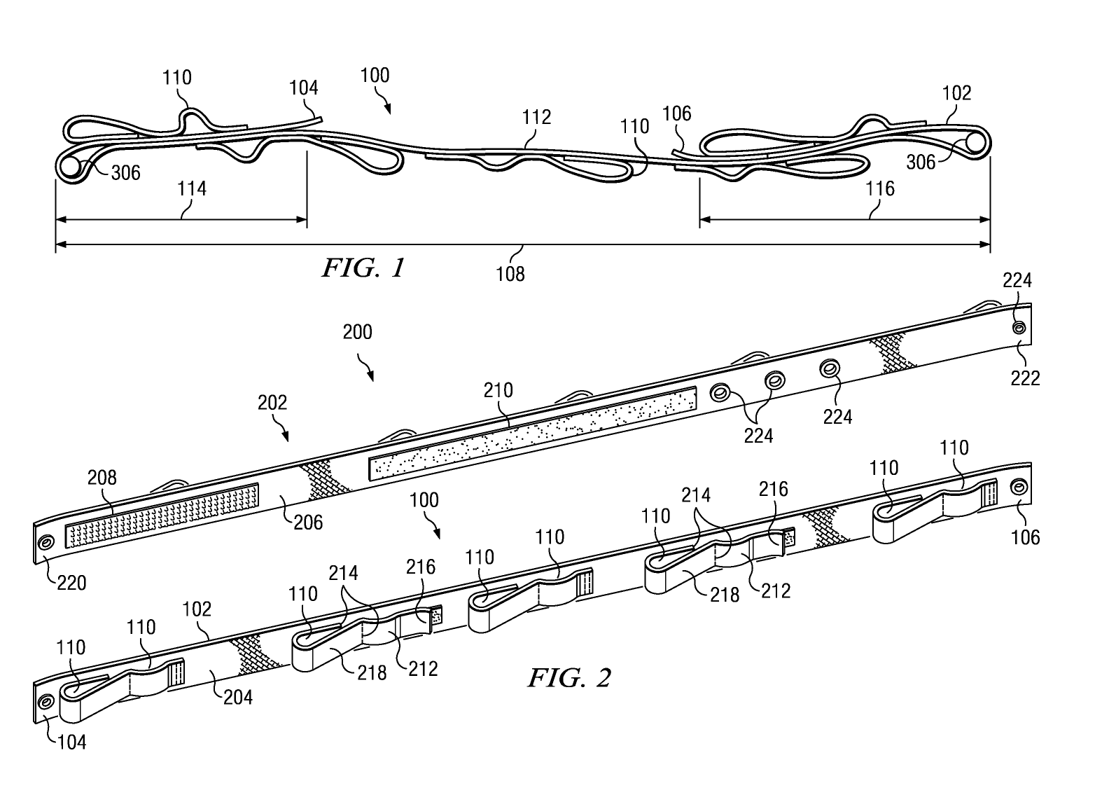

Referring to FIGS. 1 and 2, an adjustable-length organizer, indicated generally at 100, has an elongate strap 102, a first end 104, and second end 106, and an installed length 108. The strap 102 has a first side 204 and a second side 206 (shown on a second organizer 202), and a plurality of loops 110, which are affixed to or integrated into the first side 204 of the strap 102. First fastener pieces 208 (also shown on the second organizer 202) are affixed to the second side 206 of the strap 102 to be proximate to each of the first end 104 and the second end 106. One or more second fastener pieces 210 are affixed to the second side 206 of the strap 102 so that they are remote from each of the first and second ends 104, 106 and are inward of the first fastener pieces 208. More particularly, the second fastener piece 210 may be a single piece disposed over a midpoint 112 of the strap 102; or multiple second fastener pieces 210 can be disposed around the midpoint 112.

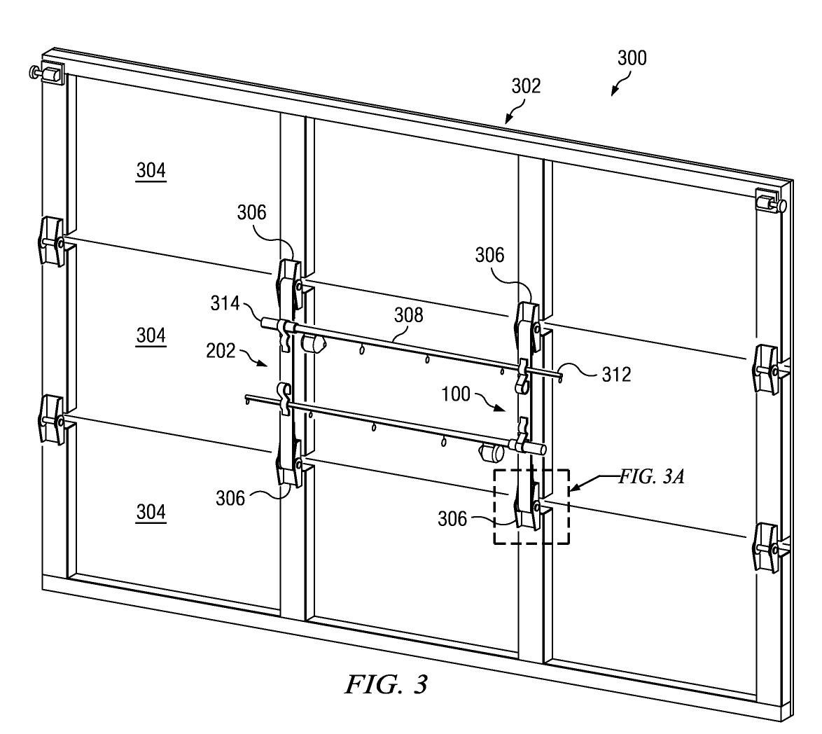

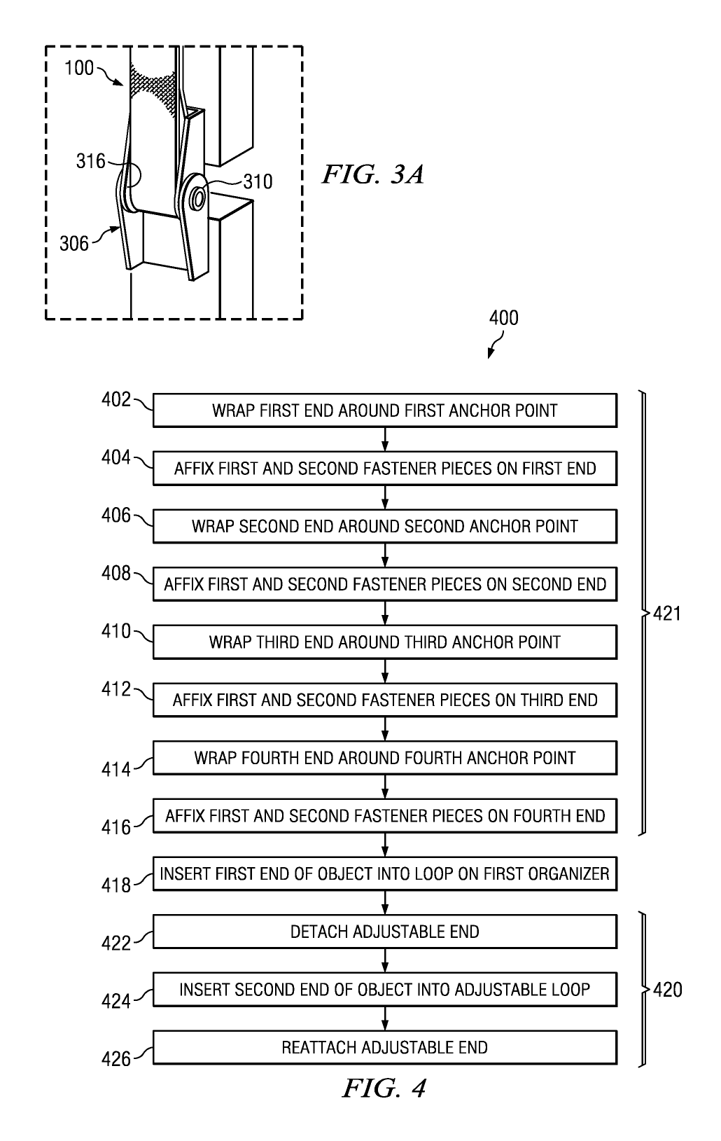

The first end 104 of the strap 102 is wrappable around a first anchor point 306, such as a hinge or rail (see FIG. 3), and the second end 106 is wrappable around a second anchor point 306. Each first fastener piece 208 is affixable to the second fastener piece 210 or pieces at a plurality of positions, making the installed length 108 adjustable. Suitable fasteners include, but are not limited to, hook-and-loop fasteners and snaps 224. By having multiple positions at which the first and second fasteners 208, 210 can be attached, the claimed organizer 100 can adjust to anchor points 306 of different spacings.

The claimed organizer can be installed anywhere one or more anchor points 306 can be found, but it is preferred that the organizer 100 be used in connection with a garage door 302 having multiple hinges 306. See FIG. 3.

More specifically, FIG. 3 shows that multiple organizers (100 and 202 of FIG. 2) may be used together to form a system, indicated generally at 300. The system 300 may include two or more organizers 100, 202 which are affixed to anchor points 306. The second organizer 202 may or may not be built to be the same as the first organizer 100. In this case, the axle 310 of the hinge of the door 302 can act as an anchor point. FIG. 3 shows that the hinges 306 used anchor the second organizer 202 are laterally offset from the hinges 306 anchoring the first organizer 100. One or more objects 308, such as fishing rods, can be inserted into the loops 110 of the organizers 100, 202 and stored indefinitely. Preferably, respective heights of the support loops 110 on the first organizer 100 substantially match the respective heights of the support loops 110 of the second organizer 202.

The unique design of the organizer 100 allows it to remain affixed to the garage door 302, regardless of whether the door 302 is open or closed, because the loops 110 allow the objects 308 to be held in or rotated into any position without becoming detached from the organizers 100, 202. Preferably, the anchors 306 have one or more side surfaces 316, which aid in preventing movement of the organizers 100, 202 laterally off of the anchors 306.

Additionally, the disclosed organizer 100 allows the position of the loops 110 to be adjusted up or down within a given set of anchor points 306 because the first and second fastener pieces 208, 210 can be adjusted relative to one another, even on a set of anchor points 306 having a single predetermined spacing. Stated differently, when installed, the first fastener piece 208 can be affixed to the second fastener piece 210 at a first displacement 114, or distance, from the first anchor point 306, which is different from a second displacement 116 of the other first fastener piece 208 away from the second anchor point 306. See FIG. 1. This adjusts the position of the loops 110 in between the anchor points 306.

Referring back to FIGS. 1 and 2, the support loops 110 can take a variety of forms. Specifically, the support loops 110 may be elastic in nature, e.g. made of a rubber-type material, or nonelastic, such as the hook-and-loop material shown in FIGS. 1 and 2. The illustrated organizer 100 has two types of support loops 110. The first is an adjustable loop 212 having a secured end 214 and an adjustable end 216. The adjustable end 216 can be moved to accommodate different sizes of objects 308 and to provide a fit that prevents lateral movement of the object 308 within the support loop 212, preventing the object 308 from falling out of the organizer 100. Hook-and-loop fasteners are preferred materials for the adjustable loop 212.

FIGS. 1 and 2 also show that the support loops 110 can be fixed loops 218. In contrast to the adjustable loops 212, the fixed loops 218 have two secured ends 214, one of which may be shared with an adjustable loop 212, as shown in the figures. It is contemplated that fixed loops 212 may be either elastic or inelastic, as described above.

According to another aspect of the invention and referring to FIG. 4, a method, indicated generally at 400, of storing objects 308 includes the step of wrapping (402) the first end 104 of the first adjustable-length organizer 100 around a first anchor point 306. The user then affixes (404) the first fastener piece 208, which is proximate the first end 104 of the first organizer 100, to the second fastener piece 210, which is remote from the first end and inward of the first fastener piece.

A second end 106 of the first organizer 100 is then wrapped (406) around the second anchor point 306, and the first fastener piece 208, which is proximate the second end 106 of the first organizer 100 is affixed (408) to a second fastener piece 210, which is remote from the second end 106 and inward of the first fastener piece 208.

A third end 220 of a second adjustable-length organizer 202 is wrapped (410) around a third anchor point 306, and a first fastener piece 208 that is proximate the third end 220 of the second organizer 202 is affixed (412) to a second fastener piece, which is remote from the third end and inward of the first fastener piece 208. A fourth end 222 of the second organizer 202 is wrapped (414) around a fourth anchor point 306 and, as above, a first fastener piece 208 that is proximate the fourth end 222 is affixed (416) to a second fastener piece 210, which is remote from the fourth end 222 and inward of the first fastener piece 208.

Steps (402)-(416) can be used to adjust (421) the positions of the loops 110 on one or more of the organizers 100, 202 up or down between the anchor points 306. As described above, this can be done by affixing (404), (412) the first fastener pieces 208 on the first and/or third ends 104, 220 to the second fastener pieces 210 at a first displacement 114 from the first and/or third anchor points 306. The first fastener pieces 208 on the second and/or fourth ends 106, 222 are then affixed (408), (416) to the second fastener pieces 210 at a second displacement 116 from the second and/or fourth anchor points 306.

Once the organizers 100, 202 are affixed to the anchor points 306, the object 308 or objects may be inserted into the organizers 100, 202 by inserting (418) a first end 312 of the object 308 into a loop 110 of the first organizer 100 and inserting (420) a second end 314 of the object 308 into a loop 110 of the second organizer 202. If any of the loops 110 is an adjustable loop 212 having an adjustable end 216, either step of inserting (418), (420) may further include the substeps of detaching (422) the adjustable end 216 of the adjustable loop 212, inserting (424) the end 312, 314 of the object 308 into the adjustable loop 212, and reattaching (426) the adjustable end 216.

In summary, the claimed organizer and systems provide a novel method for using previously under-utilized spaces to store objects. The organizers can be used to store elongate objects that are difficult to store, such as fishing poles, without the objects getting tangled or intertwined with one another. Additionally, when installed, the organizers can be rotated into any position without the objects becoming detached from the organizer

While illustrated embodiments of the present invention have been described and illustrated in the appended drawings, the present invention is not limited thereto but only by the scope and spirit of the appended claims.

We claim:

1. A system for storing objects, the system comprising:
a garage door having a plurality of panels, at least one panel being connected to two adjacent panels by a plurality of hinges, the hinges including a first hinge and a second hinge having a vertical spacing from the first hinge;
an organizer including
a flexible elongate strap having a first side, a second side, a first end, and a second end remote from the first end;
a plurality of support loops on the first side of the elongate strap;
a plurality of first fastener pieces affixed to the second side of the elongate strap, the respective first fastener pieces being proximate to respective ones of the first and second ends; and
at least one second fastener piece affixed to the second side of the elongate strap to be remote from the first and second ends and inward of the respective first fastener pieces;
wherein the first and second ends are wrappable around portions of the respective first and second hinges, each first fastener piece being affixable to the at least one second fastener piece at a plurality of positions, thereby making an installed length of the first organizer adjustable to the vertical spacing.

2. The system of claim 1, wherein at least one support loop is nonelastic.

3. The system of claim 1, wherein the first and second fastener pieces are hook-and-loop fasteners.

4. The system of claim 1, wherein the first and second fastener pieces are snaps.

5. The system of claim 1, wherein at least one support loop is an adjustable loop, the adjustable loop having an adjustable end and a secured end.

6. The system of claim 5, further comprising a fixed loop adjacent to the adjustable loop, the fixed loop having a first secured end and a second secured end, the second secured end being the secured end of the adjustable loop.

7. The system of claim 1, wherein the organizer is a first organizer, the system further comprising a second organizer having
a second flexible elongate strap having a third side, a fourth side, a third end, and a fourth end remote from the third end;
a plurality of support loops on the third side of the second elongate strap;
a plurality of first fastener pieces affixed to the fourth side of the second elongate strap, the respective first fastener pieces being proximate to the third and fourth ends; and
at least one second fastener piece affixed to the fourth side of the second elongate strap and to be remote from the third and fourth ends, inward of the respective first fastener pieces;
wherein the third and fourth ends are wrappable around a portion of respective third and fourth hinges disposed to be laterally offset from the first and second hinges on the garage door panels, heights of the support loops of the first organizer on the garage door panel substantially matching heights of the support loops of the second organizer on the garage door panel.

8. An adjustable-length organizer comprising:
an elongate flexible strap having a first side, a second side, a first end, and a second end remote from the first end;
a plurality of support loops on the first side of the elongate strap;
a plurality of first fastener pieces affixed to the second side of the elongate strap, the respective first fastener pieces being proximate to respective ones of the first and second ends; and
at least one second fastener piece affixed to the second side of the elongate strap to be remote from the first and second ends and inward of the respective first fastener pieces;
wherein the first end is wrappable around a first anchor point, the second end is wrappable around a second anchor point, and each first fastener piece is affixable to the at least one second fastener piece at a plurality of positions, thereby making an installed length between anchor points adjustable.

9. The organizer of claim 8, wherein at least one support loop is an adjustable loop, the adjustable loop having an adjustable end and a secured end.

10. The organizer of claim 9, wherein the adjustable loop prevents lateral movement of an object within the loop.

11. A system for storing objects comprising:
a first anchor point;
a second anchor point;
a first organizer having an installed length adjustable to the distance between the first and second anchor points, the organizer including
an elongate flexible strap having a first side, a second side, a first end, a second end, and an installed length;
a plurality of support loops on the first side of the elongate strap;
a plurality of first fastener pieces affixed to the second side of the elongate strap, the respective first fastener pieces being proximate to the first and second ends; and
at least one second fastener piece affixed to the second side of the elongate strap and to be remote from the first and second ends, inward of the respective first fastener pieces;
wherein the first end is wrappable around the first anchor point, the second end is wrappable around the second anchor point, and each first fastener piece is affixable to the at least one second fastener piece at a plurality of positions, thereby making the installed length adjustable.

12. The system of claim 11, wherein at least one support loop is an adjustable loop, the adjustable loop having an adjustable end and a secured end.

13. The system of claim 12, further comprising a first end of an object disposed within the adjustable loop, the adjustable loop preventing lateral movement of the first end within the adjustable loop.

14. The system of claim 11, wherein for any of a plurality of adjusted installed lengths, the first fastener piece is affixed to the second fastener piece at one of a plurality of displacements away from the first anchor point which is different from the displacement of the other first fastener piece away from the second anchor point, thereby adjusting the position of the loop in between the first and second anchor points.

15. The system of claim 11, further comprising
a third anchor point laterally displaced from the first anchor point;
a fourth anchor point displaced from the second anchor point;
a second organizer having a second installed length adjustable to a distance between the third and fourth anchor points, the second organizer including
a second flexible elongate strap having a third side, a fourth side, a third end, and a fourth end;
a plurality of support loops on the third side of the second elongate strap;
a plurality of first fastener pieces affixed to the fourth side of the second elongate strap, the respective first fastener pieces being proximate to the third and fourth ends; and
at least one second fastener piece affixed to the fourth side of the second elongate strap to be remote from the third and fourth ends and inward of the respective first fastener pieces;
wherein the third end is wrappable around the third anchor point, the fourth end is wrappable around the fourth anchor point, heights of the support loops of the first organizer with respect to the first and second anchor points substantially matching heights of the support loops of the second organizer.

16. The system of claim 11, wherein the first and second anchor points are garage door hinges.

17. A method of storing objects comprises the steps of:
wrapping a first end of a first adjustable-length organizer around a first anchor point;
affixing a first fastener piece proximate the first end of the first organizer to a second fastener piece remote from the first end and inward, on the strap, from the first fastener piece;
wrapping a second end of the first organizer around a second anchor point displaced from the first anchor point by a first installed length;
affixing a first fastener piece proximate the second end of the first organizer to a second fastener piece remote from the second end and inward, on the strap, from the first fastener piece;
wrapping a third end of a second adjustable-length organizer around a third anchor point;
affixing a first fastener piece proximate the third end of the second organizer to a second fastener piece remote from the third end and inward, on the strap, from the first fastener piece;
wrapping a fourth end of the second organizer around a fourth anchor point displaced from the third anchor point by a second installed length;
affixing a first fastener piece proximate the fourth end of the second organizer to a second fastener piece remote from the fourth end and inward, on the strap, from the first fastener piece;
inserting a first end of an object into a loop affixed to a first side of the first organizer; and
inserting a second end of the object into a loop affixed to a first side of the second organizer.

18. The method of claim 17, wherein the loop of the second organizer is an adjustable loop having an adjustable end, the step of inserting the second end of the object further comprising the substeps of
detaching the adjustable end of the adjustable loop;
inserting the second end of the object into the adjustable loop; and
reattaching the adjustable end.

19. The method of claim 17, further comprising the step of adjusting the heights of the loops within a set of anchors.

20. A method of storing objects on a garage door having a plurality of panels and a plurality of hinges, the method comprising the steps of:
wrapping a first end of a first adjustable-length organizer around a first garage door hinge;
affixing a first fastener piece proximate the first end of the first organizer to a second fastener piece remote from the first end and inward, on the strap, from the first fastener piece;
wrapping a second end of the first organizer around a second garage door hinge vertically displaced from the garage door hinge by a first installed length;
affixing a first fastener piece proximate the second end of the first organizer to a second fastener piece remote from the second end and inward, on the strap, from the first fastener piece;
wrapping a third end of a second adjustable-length organizer around a third garage door hinge laterally displaced from the first garage door hinge;
affixing a first fastener piece proximate the third end of the second organizer to a second fastener piece remote from the third end and inward, on the strap, from the first fastener piece;
wrapping a fourth end of the second organizer around a fourth garage door hinge vertically displaced from the third garage door hinge by a second installed length;
affixing a first fastener piece proximate the fourth end of the second organizer to a second fastener piece remote from the fourth end and inward, on the strap, from the first fastener piece;
inserting a first end of an object into a loop affixed to a first side of the first organizer; and
inserting a second end of the object into a loop affixed to a first side of the second organizer.
